(19) United States
(12) Patent Application Publication
(10) Pub. No.: US 2011/0131244 A1
(43) Pub. Date: Jun. 2, 2011

(54) EXTRACTION OF CERTAIN TYPES OF ENTITIES

(75) Inventors: Amir J. Padovitz, Redmond, WA (US); Matthew F. Hurst, Seattle, WA (US)

(73) Assignee: MICROSOFT CORPORATION, Redmond, WA (US)

(21) Appl. No.: 12/626,905

(22) Filed: Nov. 29, 2009

(51) Int. Cl. G06F 17/30; G06F 15/18

(52) U.S. Cl. 707/776; 707/769; 706/12; 707/E17.014

(57) ABSTRACT

Certain types of entities may be extracted from a document. In one example, the entities to be recognized are cultural entities, such as the names of movies, video games, books, etc. For each such entity, a concept graph may be built that shows the relationship between the entity itself and other entities, such as the relationship between a movie and the actor(s) who act in the movie. When a candidate entity name is detected in the document, the concept graph may be used to look for other entities that appear in the context of the candidate entity. The presence of related entities in the context of the candidate may be used to disambiguate the meaning of the candidate. For example, a common word like “up” might be recognized as the name of a movie if the names of actors or characters in that movie appear near the word “up”.

### BACKGROUND

Entity recognition is a common task in information processing. Entity recognition is typically performed on unstructured documents, such as text documents collected from the web. The entity recognition process seeks to identify named entities mentioned in the text. An entity may be anything with a name—e.g., a person, a city, a famous work of art, etc.

A typical entity recognizer uses a knowledge base of entities, and attempts to recognize those entities in a document that is being examined. The knowledge base contains a list of known entities, a canonical name for each entity (which distinguishes that entity from other entities in the knowledge base), and a set of one or more surface forms for each entity. The surface forms are the forms that are likely to be encountered in a document, and a given entity may have more than one surface form. For example, an entity might be the person whose name is “John Smith”. The canonical name for that entity might be “John Q. Smith, Jr.”, and the various surface forms of his name might be “John Smith”, “J. Smith”, “J. Q. Smith”, etc. Thus, an entity recognizer might look for these surface forms in the document. If one of these surface forms is observed in the document, the entity recognizer may declare that the entity “John Q. Smith, Jr.” has been observed in the document. Some sophisticated entity recognition techniques may take context into account when determining whether a match to one of the surface forms has been found (where context may refer to surrounding words, the title of the document, or any other information).

One issue that arises in entity recognition is that of recognizing cultural entities, such as the names of movies, video games, books, etc. Person names and place names tend to have a distinctive lexicon—e.g., the word “Fred” generally has no meaning other than as a person's name. On the other hand, cultural entities generally have names that are ambiguous in the sense that they might refer to a cultural entity or might simply be words used in their normal sense. For example, the word “up” might refer to the name of a movie, the name of a video game based on the movie, a music album that is unrelated to either the movie or the video game—or might simply be used as an English adjective. Thus, identifying and disambiguating cultural entities presents a challenge.

### SUMMARY

Entities may be identified and disambiguated by using knowledge about the entities. Knowledge about cultural entities can be mined from existing resources. For example, there are databases of information about movies, books, video games, etc., from which concepts associated with the entity name can be gleaned. A movie has a set of characters, a set of actors, a genre, etc., and this information can be mined from existing resources. Similarly, video games have characters (and sometimes human actors) associated with them, and this information can be mined from existing resources. Using this information, a concept graph for an entity may be built. The concept graph contains entities (e.g., the name of a movie, the name of a character in the movie, the name of an actor in the movie, etc.), and the relationships between these entities. If an ambiguous term that might (or might not) refer to a cultural entity, that term can be compared to other entities that appear in a concept graph. If the ambiguous term refers to a particular cultural entity, then it is likely that other terms from the concept graph will appear in the ambiguous entity's context. Additionally, words relating to a certain type of cultural entity might tend to appear near entities of that type. For example, “up” may be both a movie and a video game, but terms like “play,” “high score,” “Xbox,” etc., are more likely to appear near the word “up” when that term refers to the video game. In this way, it can be determined whether a given term refers to a cultural entity, and, if so, which type of cultural entity the term refers to.

Relationship in a concept graph can be measured to determine a degree of affinity, or relatedness, among concepts. The significance of a particular degree of relatedness can be determined using adaptive machine learning techniques. For example, concepts in a concept graph may be assigned affinity measures such as one, two, three, etc. The higher the affinity measure, the less related two concepts may be. Different types of measures of relatedness can be defined, and the different measures can be used with different disambiguation algorithms. Disambiguation may be performed by a parameterized classifier whose parameters specify how the relatedness of concepts in the concept graph affect the disambiguation decision. Machine learning techniques may be used to optimize the parameters in order to assign the appropriate significance to a given degree of relatedness among concepts.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flow diagram of an example process in which cultural entities may be extracted from a document.

FIG. 2 is a block diagram of an example concept graph.

FIG. 3 is a block diagram that shows components that may be used to extract information from documents in order to build a concept graph.

FIGS. 4 and 5 are block diagrams of two types of measures of affinity.

FIG. 6 is a block diagram of an example system that may be used to recognize cultural entities in a document.

FIG. 7 is a block diagram of example components that may be used in connection with implementations of the subject matter described herein.

### DETAILED DESCRIPTION

Entity recognition is a process in which text is evaluated to identify and classify atomic elements. For example, the phrase “John Smith” might refer to a specific person. An entity recognition process may detect the presence of that phrase in a text, and may recognize that the phrase refers to a specific person.

In the simplest examples of entity recognition, a specific phrase unambiguously identifies a specific entity. In such an example, “John Smith” would refer to a specific person, and not to any other person or entity. In reality, entity detection is rarely this simple. A given person's name may have several different surface forms—e.g., “John Smith”, “John Q. Smith”, and “Johnny Smith” all may refer to the same person. Or, the same phrase may refer to different entities—e.g., there may be several people named “John Smith”, in which case the phrase “John Smith”, when detected in a text, has an ambiguous meaning. Various techniques have been devised to help to disambiguate entities.

One vexing problem in entity recognition is disambiguation of cultural entities. Cultural entities are entities whose meaning arises from popular culture, such as the titles of movies, books, video games, etc. One problem that arises is that, in some cases, cultural entities lack distinctness, which makes them difficult to distinguish from ordinary words. For example, in 2009 a movie named “Up” was released. However, “up” is a common English word. It is easy to use standard pattern matching techniques to detect the presence of the word “up” in a text. It is more difficult to determine whether that word is being used in its normal English sense, or as the title of a movie. Another problem that arises is that the same name may refer to several different entities. For example, the phrase “The Lord of the Rings” refers to a set of books, a set of movies, a set of video games, and various other products. Merely recognizing the phrase “The Lord of the Rings” in a text does not unambiguously identify which entity is being referenced.

The subject matter described herein provides a way to extract cultural entities from text. The techniques herein may be used to extract any type of cultural entities (entities related to movies, books, video games, music, television, etc.) from any type of text. These techniques use contextual clues to determine whether a particular phrase refers to a cultural entity, and what type of entity the phrase refers to. Information concerning cultural entities may be mined from readily available data sources, and the mined information may be used to recognize entities. Databases of movies are available on the web. These databases could be used to identify the titles of movies, as well as the names of actors and characters in the movies, the genre of the movie, etc. For example, the movie “Up” has characters named Russell and Carl. If the word “up” appears near these names, that fact suggests that the word “up” is referring to the title of a movie rather than an ordinary English adjective. A name like “The Lord of the Rings” is highly distinctive, and it is unlikely that this phrase would refer to anything other than a cultural entity. However, determining whether it refers to a book, a movie, a video game, etc. is more challenging, but context can be used to make that determination. For example, if the phrase “The Lord of the Rings” occurs in proximity to words that suggest video games (e.g., “play”, “scores”, “Xbox”, etc.), this fact suggests that the phrase refers to a video game. Other phrases (e.g., “film,” “academy award,” “theater,” “rated PG,” etc.), may suggest that the “The Lord of the Rings” refers to a movie.

Various algorithms described herein may be used to determine when a word or phrase refers to a cultural entity, and also to determine which entity the word of phrase refers to when different types of cultural entities have the same name. Additionally, machine learning techniques may be used to tune the algorithms in order to affect the way that they use information about cultural entities to disambiguate words or phrases.

Since the techniques described herein can work with any type of semantic resource, these techniques may provide the following aspects:
They may be automatically usable in multiple domains.
They may be usable for a variety of entity extraction task types.
They may provide grounding to the entity extraction results.
They may provide organizational, navigational and inference capabilities to applications consuming the results.
Deployed systems may be modified and optimized at runtime without retraining.

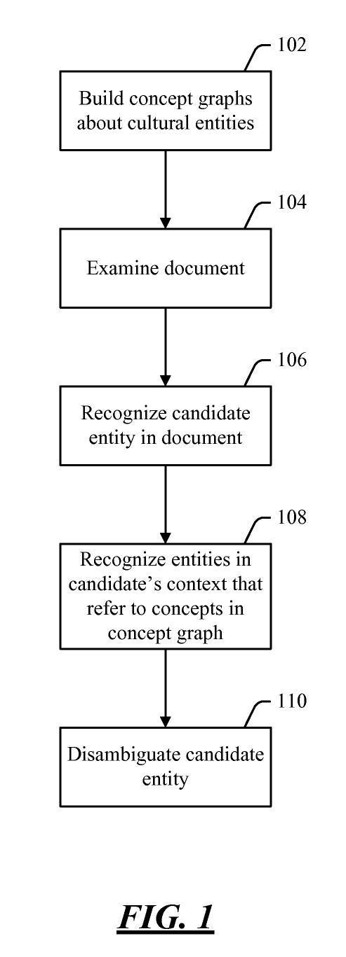

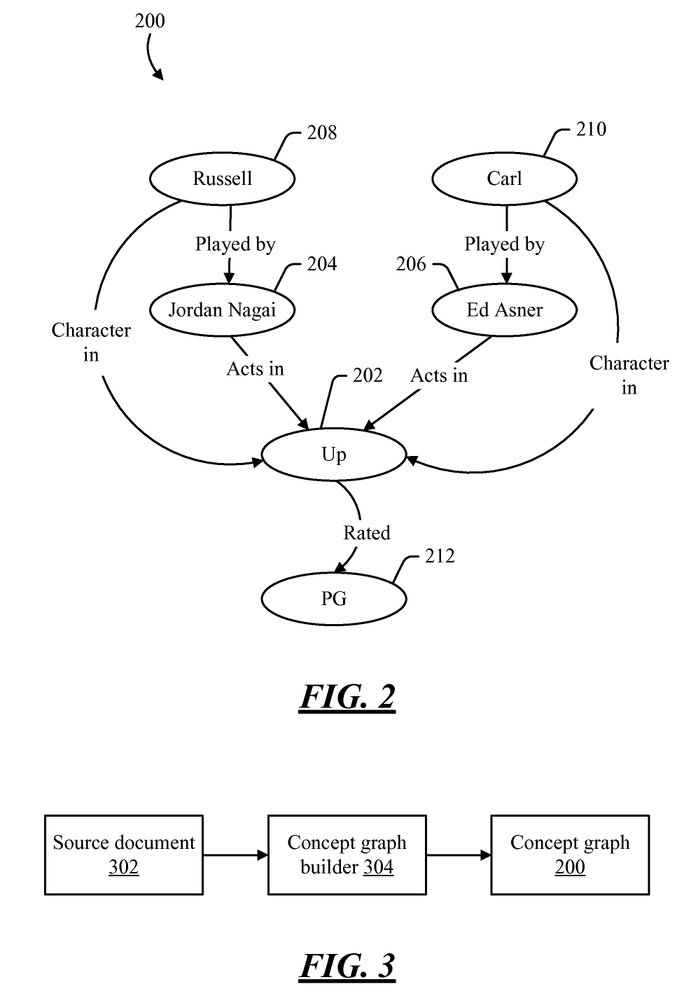

Turning now to the drawings, FIG. 1 shows an example process in which cultural entities may be extracted from a document. At 102, concept graphs may be built about cultural entities. For example, one type of cultural entity is a movie. A movie has various facts that are true about it—e.g., the movie has a title, a set of characters, a set of actors who play the characters, a director, a genre, etc. These specific facts may be related to each other in a particular way. For example, FIG. 2 shows an example concept graph 200 for the movie whose title is “Up”. The name of the movie is shown at node 202. Other nodes contain other names that have various relationships to node 202. For example, Jordan Nagai and Ed Asner were actors in the movie “Up”. The characters they played were named Russell and Carl. The Motion Picture Association of America (MPAA) gave “Up” a rating of PG. Each of these facts has a node in concept graph 200, and the edges of concept graph show the relationships between these nodes. Thus, Jordan Nagai (node 204) and Ed Asner (node 206) are connected to the title node 202 by the relationship “acts in”, indicating that they were both actors in the movie. The characters Russell (node 208) and Carl (node 210) are connected to their respective actors (nodes 204 and 206) by a “played by” relationship. These character nodes may also be connected to the title node 202 by a “character in” relationship, indicating that they are characters in the movie “Up”. Node 212 indicates the rating that the MPAA gave to the movie, and the title node 202 is connected to node 212 by a “rated” relationship.

Concept graph 200 provides a simple example of one way to model a particular type of cultural entity. However, this example shows that a cultural entity may be described both by its name (“Up”, in this example), as well as by its relationship to other entities (e.g., characters, actors, ratings, genres, etc.).

Returning now to FIG. 2, at 104 a document, from which cultural entities are to be extracted, is examined. For example, a web crawler might examiner a web document in order to index the entities that appear in the document. Within the document to be examined, a candidate entity is recognized (at 106), based on a comparison of the surface forms of various cultural entities with words in the document. A candidate entity is a word or sequence of words for which a possibility exists that the word or sequence of words might be the name of a cultural entity. For example, if the word “up” appears in a document, that word might refer to the movie by that name, or might merely be used as an adjective in the English language. The phrase “they live” might be a simple subject-verb combination, or it might refer to a 1988 film of that name. “Parks and recreation” might refer to the name of a municipal department, or it might refer to a 2009 television show of that name. Therefore, these words and phrases are candidate entities, in the sense that any of them might refer to a cultural entity.

At 108, the context of a candidate entity is examined to determine whether it contains other entities that appear in the candidate entity's concept graph. Each node in the graph defines an entity that can be recognized in a document. In the example of FIG. 2, “Ed Asner”, “Jordan Nagai”, and “PG” are all entities, each of which has its own node in the concept graph. Thus, when the word “up” is detected in a document, “up” becomes a candidate in the sense that it might refer to a cultural entity (i.e., the movie by that name). In order to determine whether it actually does refer to such an entity, text near the candidate (or, more generally, text in the candidate's context) is examined to determine whether any of this text matches other entities in the concept graph. For example, if the phrase “Jordan Nagai” appears near the word “up”, this fact tends to suggest that the word “up” refers to the movie rather than the adjective, since Jordan Nagai is an actor in the movie. Using techniques such as this one, a candidate entity (such as the word “up”) is disambiguated at 110.

What follows is a description of the particular way(s) that entities in the concept graph—as well as other information—are used to disambiguate candidates. Using the techniques described below, it can be determined whether a candidate refers to a cultural entity, and which cultural entity it refers to. For example, techniques that follow may be used to determine whether the word “up” in a document refers to an ordinary word or a cultural entity. If it is found to refer to a cultural entity, these techniques may be used to determine which cultural entity it refers to. For example, the techniques described herein may be used to determine whether the word “up” refers to a movie by that name, a video game based on the movie, a 2002 Peter Gabriel musical album by that name, or just the English adjective “up”.

In order to understand how to recognize and disambiguate cultural entities, consider the following example. Suppose one is looking for references to video games. An entity extractor that is examining a document may see the word “Black,” which is known to be identical to the name of a video game, although that word could refer to a large number of things of things other than the video game of that name. Since the nature of the observed use of the word “Black” is ambiguous, it is a candidate in the sense that it might refer to a video game. However, it is known that video games are things of a certain type, and that certain actions (e.g., play, buy, win, lose, etc.) are associated with things of that type. Therefore, if actions such as win, lose, etc., are mentioned somewhere near the word “Black” (or, more generally, in the context of that word), then the word “Black” is more likely to be a mention of a game than if those actions had not appeared near the word “Black.” Likewise, other facts may be present that suggest that the word “Black” refers to a video game of that name. Video games tend to be purchased at certain stores with distinctive names (e.g., “GameStop”, “EB Games”, etc.), tend to be played on specific consoles (e.g., “Xbox”, “PS3”, etc.), and tend to be discussed on specific web sites devoted to video games. Thus, if this type of information appears in the context of the word “Black”, this fact increases the probability that the word “Black” refers to a video game instead of referring to something else. Information such as the consoles on which games are played, stores in which they are sold, the names of video game blogs, actions associated with video games, and other information can be mined from an appropriate semantic resource, such as a Wikipedia article on video games. Additionally, there are semantic resources from which concepts relating specifically to the “Black” video game can be mined (e.g., the names of characters or places that appear in the game), and the presence of those concepts in the context of the word “black” may suggest that an instance of the word “black” refers to the video game of that name.

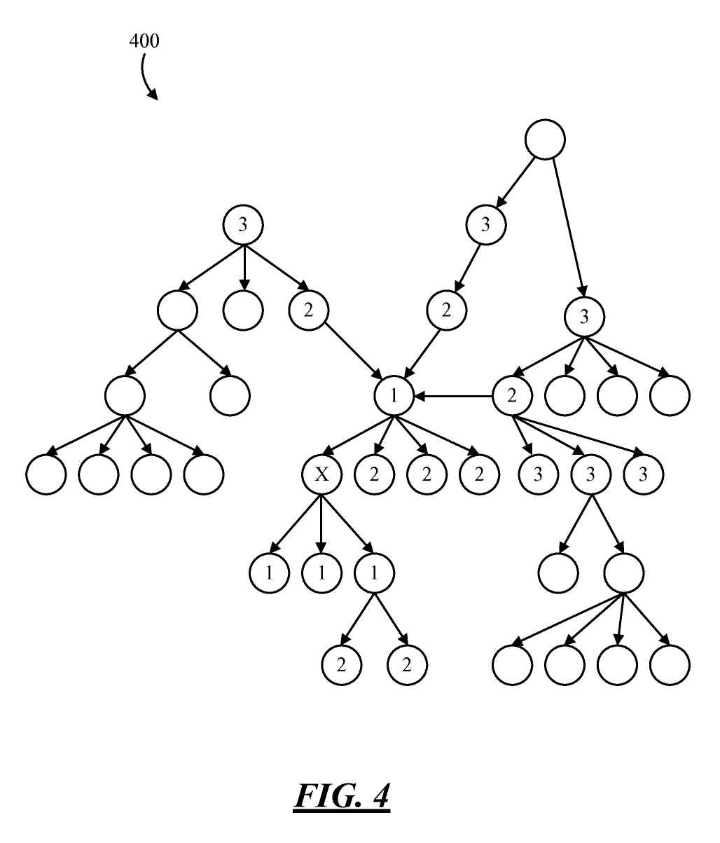

Semantic resources, such as the Wikipedia pages or other web pages mentioned above, may be mined in order to build a concept graph. FIG. 2, discussed above, is an example of a concept graph relating to the movie “Up.” Other concept graphs could be built (e.g., relating to the video game “Black”, or to some other cultural entity). In general, the concept graph is built by extracting information from documents. FIG. 3 shows a set of components that may be used to extract information from such documents. In the example of FIG. 3, source document 302 is provided as input to a concept graph builder 304. Concept graph builder 304 examines source document 302 and evaluates the information contained therein to build a concept graph, such as concept graph 200 (first shown in FIG. 2). Extracting information from source document 302 may be performed using any extraction technique. Concept graph 200 typically takes the form of a Directed Acyclic Graph (DAG), although concept graph 200 could be a generalized graph.

The following is a description of how graphs that have been built may be used to recognize cultural entities. Let the knowledge about concepts in selected domains be defined by ontology comprising the set C of concepts, the set R of relations (each relation being defined over two concepts, and the set A of attributes, each attribute being defined over a concept.) The ontology may be represented in a DAG, with concepts are denoted by nodes in the graph and relations as edges relating one concept to another. Nodes in the graphs are the entities for extraction, each associated with a weight α, where 0≦α≦1, where α is a measure of distinctiveness of the concept in reference to the ontology and in reference to other objects in the world. For example, the word “they” may be the name of a cultural entity, but it also appears frequently as an ordinary English pronoun. Therefore, the word “they” is a highly ambiguous cultural reference, so such a word could be assigned a very low α value. On the other hand, the word “Xbox” is rarely used to refer to anything other than a video game console, which makes it a very unambiguous cultural reference. Therefore, “Xbox” could be assigned a high α value.

Let “-” be a binary operator that is applied to two nodes and returns the minimum number of edges in sequence connecting the nodes. For examples, if cᵢ and cⱼ are nodes, then cᵢ−cⱼ=n, where n is the minimum number of edges that one would have to follow to travel from cᵢ to cⱼ. For every pair of concepts cᵢ and cⱼ, one may compute the “degree of affinity,” affin(cᵢ, cⱼ), representing degree of relatedness. There are two such types of affinity, defined by equations (1) and (2):

affin₁(cᵢ,cⱼ)=cᵢ−cⱼ if such exists (1)

affin₂(cᵢ,cⱼ)=lca _{R̅}(cᵢ,cⱼ), if such exists (2)

In equation (2), R̅εR is a subset of relations from the element set R (which contains fewer than all of the edges in R), and lca _{R̅}(cᵢ,cⱼ) is a least common ancestor function applied over cᵢ and cⱼ that considers only relations in R̅. C̅εC is a subset of concepts that are connected through the edges R̅, so cᵢ, cⱼε C̅.

Equations (1) and (2) represent two notions of affinity between concepts in a graph. These different concepts of affinity are used in two algorithms described below. Intuitively, equation (1) is a simple distance between concepts, based on the number of nodes that one has to pass through to get from concept cᵢ to concept cⱼ—i.e., the number of edges that would be traversed on a path between concepts cᵢ and cⱼ. Equation (2), on the other hand, places significance on specific kinds of relations that have the capacity to indicate strong relatedness to other concepts. For example, relations of the form “type of” (concept cᵢ is a type of concept cⱼ), or “part of” (concept cᵢ is a part of concept cⱼ) tend to indicate a particular type of relatedness among concepts beyond the mere proximity that is measured by equation (1).

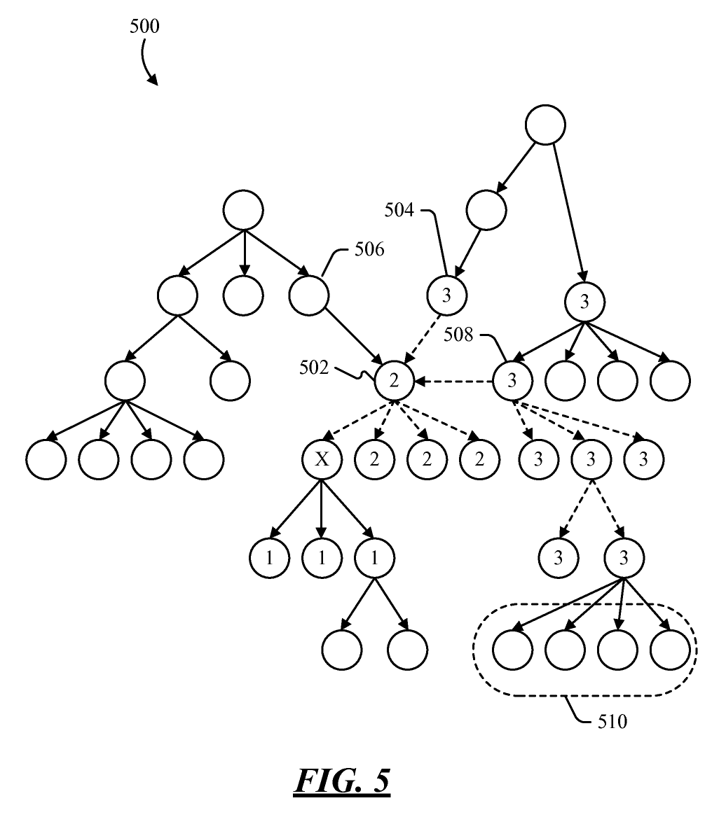

FIGS. 4 and 5 show the affinity measures from equations (1) and (2) respectively. In FIG. 4, graph 400 is a directed acyclic graph (DAG). Graph 400 contains a node marked “X”. The numbered nodes in the graph show the degree of affinity between other nodes and the “X” node, as measured by equation (1). In particular nodes that are marked with a “1” are one edge away from the “X” node, nodes that are marked with a “2” are two edges away from the “X” node, and so on. The nodes that are marked with neither an “X” nor a number have an undefined (or non-existent) affinity to the “X” node, since there is no path by which one can travel from the “X” node to these unmarked nodes, or from one of the unmarked nodes to the “X” node. (The graph is directed, so—in considering distance according to equation (1)—one can only count a path between two nodes as existing if the path travels in the direction of the arrows along all of the edges that connect the two nodes.)

In FIG. 5, graph 500 is also a directed acyclic graph (actually, the same DAG as graph 400 of FIG. 4), but affinities to the “X” node are calculated according to equation (2) instead of equation (1). In graph 500, the dotted line show the edges (relations between concepts) that are members of R̅. Equation (2) calculates the distance to the least common ancestor of the “X” node and the other nodes in graph 500. However, for the purpose of equation (2), only certain least common ancestors are counted. As will be recalled, C̅ is the set of concepts (nodes) that are connected by edges in R̅, so equation (2) counts a node as having a least common ancestor only if that ancestor is a member of C̅, and only based on lengths of paths that are contained within R̅.

In order to apply equation (2), first level affinity to the “X” node is initially determined by identifying those nodes that can be reached from “X” in one hop. Observing the direction of the arrows, the only three nodes that can be reached from “X” in one hop are the three nodes that are marked with a “1”. Other nodes are then assigned affinities greater than 1 as follows. A node that can reach the “X” node through a single directed edge in R̅ has an affinity of “2”. In graph 500, node 502 is a “2” node, since there is a single dotted line edge that points from node 502 to the “X” node. Any node that can be reached from a “2” node using only directed edges in R̅ is also a “2” node. Any node that has a directed edge leading from itself to a “2” node is a “3” node. For example, node 504 does not have a single directed edge in R̅ from itself to the “X” node, and is therefore not a “2” node. However, node 504 does have a single directed edge in R̅ from itself to node 502, which is a “2” node, so node 504 has an affinity of “3”. Node 506 has a single directed edge from itself to node 502, but node 506 is not a “3” node because the edge that leads to node 502 is not in R̅ (as indicated by the fact that the edge is shown with a solid line). Node 508 has a single directed edge in R̅ that leads from itself to node 502, so node 508 has an affinity of “3”. Descendants of node 508 that are reachable from node 508 solely using edges in R̅ also have an affinity of “3”. Nodes that are not marked with a number do not have an affinity value according to equation (2), since there is no path from these nodes to X using edges in R̅ (and they were not assigned an affinity of “1” using the initial rule described above). For example, the nodes 510 are descendants of node 508, but they are not reachable solely using edges in R̅, so they do not have assigned affinity values.

These different affinity measures may be used in disambiguating candidate entities. For example, if a candidate entity is near another entity whose affinity in a particular graph is one, that fact may strongly indicate that the candidate entity is the cultural entity that the graph describes. If the candidate entity is near another entity whose affinity is two, this fact may also indicate that the candidate entity is the cultural entity described in the graph—although the presence of an affinity two entity does not suggest the identity of the candidate as strongly as an affinity one entity does.

In order to use a concept graph to recognize cultural entities in a document, the document is examined using an n-gram sliding window procedure to obtain partially matching candidate sections in the document. The system may consider partial matches in order to account for different surface representations of the same concept. For example, the canonical name for an entity might be “The Lord of the Rings”, although the partial match “Lord of the Rings” might be accepted as a candidate.

In order to effectively support wide range of cultural entities in a non-scoped environment, i.e. when the entities mentioned in text have no domain constraints, a system first attempts to distinguish between candidates mentioned in reference to existing knowledge and candidates referencing other objects in the world. For example, a text section might mention “The tenant”, and a system may attempt to determine if these words refer to a movie of that name, or to a person who rents an apartment. One way to perform this recognition is built on learning a prediction model which relies on semantic information within context as an indicator. The prediction model uses features corresponding to three dimensions: estimation of the distinctiveness of a candidate entity (e.g., the a value mentioned above), the similarity between a candidate section in text and the corresponding entity in the graph (via string similarity matching), and the degree of semantic support derived from entities in the graph that are present in context of the candidate.

Retrieval of related concepts from the concept graph can be vulnerable to varying degrees of modeling sparseness. For example, different concepts and their relationships may be defined with different degrees of detail. To address this issue, we also consider an adaptive scheme in which a favorable neighborhood distance for a set of concepts is computed based on classification feedback. In other words, we have a classifier that responds to input from the concept graph as well as a neighborhood distance, and which performance is used to identify constructive neighborhood to the set of concepts.

More formally, we have a feature space X, a binary target space Y={−1, +1} and a set of training examples (xᵢ,yᵢ)|xᵢεXᵢ, yᵢεY, i=1, . . . , N, produced for concepts in a multi-domain ontology, once. Let the neighborhood distance d̅ represent the maximum degree of affinity of concepts around a concept or set of concepts. Our classification component uses a hypothesis classifier Hᵢ(T,G,α, d̅)→{Y, [0 . . . 1]}, computed for concept cᵢ, which feature space is derived from text T, concept graph G, α, and neighborhood distance d̅ (of cᵢ). A simple adaptive procedure assesses the results produced by H(•) for d̅ using feedback. In other words, candidates are recognized, in part, based on related concepts (in a concept graph) that appear in the context of the candidate. The degree of relatedness that a recognition process looks for may be viewed as one or more parameters to a parameterized classifier. Machine learning techniques may be used to adjust the parameters based on feedback as to what degree of relatedness will help to disambiguate a candidate entity.

The following is an example of how disambiguation may be performed using information contained in concept graphs. Consider, for example, the text section “The Lord of the Rings”, which may refer to, say, twelve different cultural entities (e.g., several movies, several video games, several books, etc.). In order to disambiguate this candidate, the following approaches may be used.

The first approach (referred to herein as “Disambiguation I”) emphasizes heuristics dealing with the particular arrangement and characteristics of the ambiguous sections—for equally supported entities it favors the entities more similar to a section, and of those it favors a candidate associated with a longer section. The second approach (referred to herein as “Disambiguation II”) makes use of the notion of distance, both in the document and the concept graph. More distant nodes in the graph are considered less related, as are more distant supportive evidences within the text.

Disambiguation I works as follows. Let Nᵢ be the set of entities in the neighborhood of entity cᵢ in the concept graph, simᵢ the similarity between the section and cᵢ, secSizeᵢ the section size referring to cᵢ, and the set A={i . . . k . . . j} the conflicting candidates.

Define support for entity as

$${S}_{i} = {\sum }_{j ∈ {N}_{i} , j \neq i} {a}_{j} \qquad ( 3 )$$

Let B={ . . . m . . . }⊂A define the set of elements that satisfy max(simₘ)±δₛᵢₘ, where δₛᵤₚ and δₛᵢₘ are small fudge values. Return an entity cᵢ from the set C that maximizes secSizeᵢ.

Disambiguation II works as follows. Define the distance d_{i,j}⁰ between two entities cᵢ and cⱼ in a graph as follows:

$${d}_{i , j}^{0} = max ( \frac{\overline{d} - lca ( {c}_{i} , {c}_{j} )}{\overline{d}} , 0 ) \qquad ( 4 )$$

where d̅ is the neighborhood distance, and lca is a least common ancestor function between cᵢ and cⱼ. Let tokLen(i,j) represent the number of tokens between first tokens of two sections i and j in the text that potentially refer to concepts in the graph, and context(i) represent the total number of tokens in the context spanning candidate i. Then we define the text distance d_{j→i}^{t} between section j and section i as:

$${d}_{j \to i}^{t} = max ( \frac{context ( i ) - tokLen ( i , j )}{context ( i )} , 0 ) \qquad ( 5 )$$

Then return cᵢ that maximizes Σ_{j≠i}d_{i,j}⁰d_{j→i}^{t}.

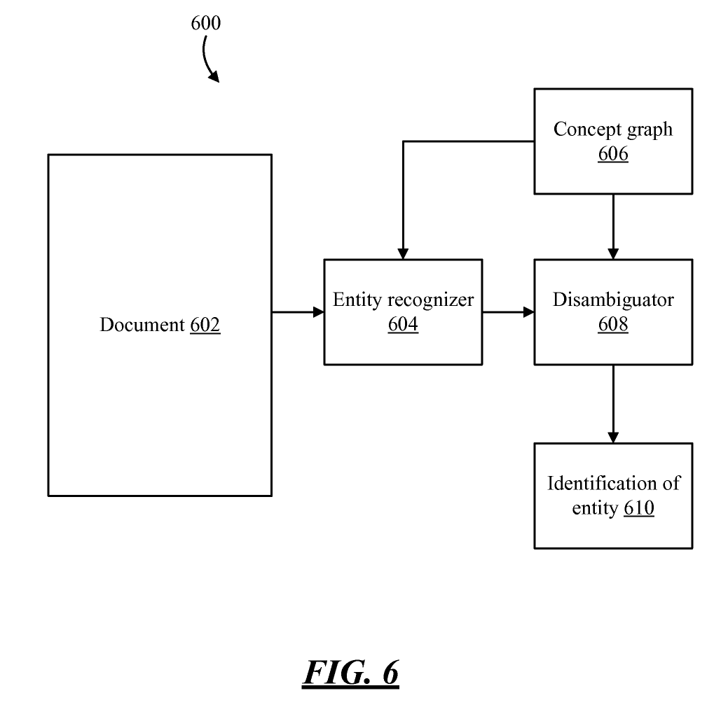

FIG. 6 shows an example system 600 that may be used to recognize cultural entities in a document. In system 600, a document 602 is received. The document is provided as input to an entity recognizer 604. The entity recognizer 604 uses a concept graph 606 to identify candidate entities. Once candidate entities have been identified, the document—with the identified candidate entities—is provided to a disambiguator 608. The disambiguator 608 also makes use of the concept graph 606, in the sense that it uses the concept graph to identify concepts that are related to the candidate entity and then looks for these related concepts in the document within the context of the candidate entity. (In general, the entity recognizer and disambiguator may use various factors, including those found in the concept graph, to recognize and/or disambiguate entities.) Once the candidate entities have been disambiguated, system 600 produces an identification 610 of a particular entity. The entity that is identified may, for example, be the name of a physical object such as a film, a video game disk, a book, etc. The identification of the entity may be communicated (e.g., to a person, to another program, etc.), and the identification may be used to product a tangible result, such as indexing documents to be searched, etc.

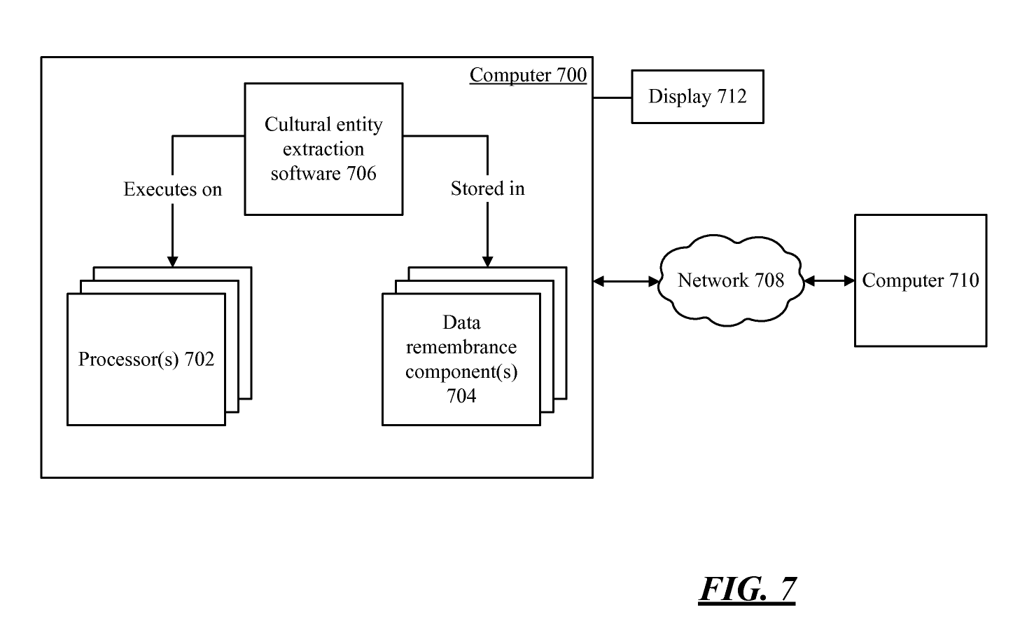

FIG. 7 shows an example environment in which aspects of the subject matter described herein may be deployed.

Computer 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is cultural entity extraction software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A personal computer in which a program is stored on hard disk, loaded into RAM, and executed on the computer's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more computer-readable storage media. (Tangible media, such as an optical disks or magnetic disks, are examples of storage media.) Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 700 may be communicatively connected to one or more other devices through network 708. Computer 710, which may be similar in structure to computer 700, is an example of a device that can be connected to computer 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that stores executable instructions to recognize entities in a document, wherein the executable instructions, when executed by a computer, cause the computer to perform acts comprising:
examining the document;
recognizing a candidate entity in the document;
recognizing one or more first entities in a context of said candidate entity, wherein said one or more first entities refer to concepts in a concept graph for a second entity;
determining, based on having recognized said one or more first entities in said context, that said candidate entity is said second entity; and
communicating a result that indicates that said second entity has been detected in said document.

2. The computer-readable storage media of claim 1, wherein said acts further comprise:
mining a document that concerns said second entity to build said concept graph, wherein said concept graph comprises a plurality of nodes connected by edges, wherein each node represents a concept relating to said second entity, and wherein each of the edges indicates a relationship between two concepts.

3. The computer-readable storage media of claim 2, wherein said acts further comprise:
calculating an affinity between two concepts in said concept graph, said affinity being based on a number of edges that have to be traversed to reach a node associated with one of said two concepts from a node associated with another one of said two concepts.

4. The computer-readable storage media of claim 2, wherein said acts further comprise:
calculating an affinity between two nodes in said concept graph, said affinity being based on a distance between one of the two nodes and a common ancestor of the two nodes.

5. The computer-readable storage media of claim 4, wherein said concept graph has a first set of edges, wherein a second set of edges is a subset of said first set of edges, and wherein existence of a common ancestor of said two nodes is based on whether said two nodes are connected to said common ancestor by a third set of edges that contained in said second set.

6. The computer-readable storage media of claim 1, wherein a plurality of entities have a same name as said second entity, and wherein said acts further comprise:
using said concept graph to determine to which of said plurality of entities said candidate entity refers.

7. The computer-readable storage media of claim 1, wherein a classifier uses said concept graph to disambiguate said candidate entity, wherein parameters of said classifier determine how relationships in said concept graph are used to disambiguate said candidate entity, and wherein said acts further comprise:
using machine learning to adjust said parameters.

8. The computer-readable storage media of claim 1, wherein said concept graph indicates distinctiveness of said first entities and said second entity, and wherein said acts further comprise:
using said distinctiveness to determine whether a word or phrase in said document is a candidate entity.

9. A method of extracting entities from a document, the method comprising:
using a processor to perform acts comprising:
recognizing a candidate entity in the document;
determining that there is a possibility that said candidate entity is a first entity;
using a concept graph of said first entity to determine what second entities relate to said first entity;
determining that one or more of said second entities appear in a context of said candidate entity in said document;
determining, based on said one or more of said second entities appearing in said context, that said candidate entity is said first entity; and
communicating a result that indicates that said second entity has been detected in said document.

10. The method of claim 9, wherein using said concept graph comprises determining affinities between said first entity and said one or more second entities by calculating distances between said first entity and said one or more second entities.

11. The method of claim 9, wherein using said concept graph comprises determining affinities between said first entity and said one or more second entities by calculating distances to a common ancestor of said first entity and said one or more second entities, wherein said distances are calculated using a subset of edges in said concept graph, and wherein said subset contains fewer than all of the edges in said concept graph.

12. The method of claim 9, wherein a determination that said candidate entity is said first entity is based on which of the second entities appear in said context, and on a degree of affinity between said second entities and said first entity in said concept graph.

13. The method of claim 12, wherein said determining that said candidate entity is said first entity is performed by a classifier whose parameters define how a degree of relationship between said first entity and said second entities affects a probability that said candidate entity is said first entity.

14. The method of claim 13, wherein a machine learning technique is used to set said parameters.

15. The method of claim 9, wherein said acts further comprise:
building said concept graph from a database that contains information concerning said first entity.

16. The method of claim 9, wherein said first entity comprises a physical object, and wherein said method recognizes a reference to said physical object in said document.

17. A system for recognizing entities in a document, the system comprising:
a processor;
a data remembrance component;
an entity recognizer that examines a document to determine whether a first entity occurs in said document, said entity recognizer identifying a first entity in said document as a candidate entity based on a comparison of a word or phrase in said document with a form of said first entity, said entity recognizer using a concept graph to identify concepts that relate to said first entity, wherein said entity recognizer determines, based on one or more factors, that said candidate entity is said first entity, wherein said entity produces an identification of said entity, and wherein said one or more factors comprise said concepts appearing in a context of said candidate entity.

18. The system of claim 17, wherein said one or more factors comprises measures of distinctiveness of said concepts.

19. The system of claim 17, wherein said one or more factors comprise a degree of affinity between said concepts.

20. The system of claim 17, wherein a plurality of entities, including said first entity, have identical surface forms, and wherein the system further comprises:
a disambiguator that uses concepts in said concept graph to determine that said candidate entity is said first entity and not any other one of said plurality of entities.
